(19) United States
(12) Patent Application Publication
(10) Pub. No.: US 2025/0201432 A1
(43) Pub. Date: Jun. 19, 2025

(54) RADIOACTIVE WASTE CONTAINER

(71) Applicant: INGECID, S.L., SANTANDER (CANTABRIA) (ES)

(72) Inventors: Jokin RICO ARENAL, SANTANDER (CANTABRIA) (ES); Francisco BALLESTER MUÑOZ, SANTANDER (CANTABRIA) (ES); Diego RODRÍGUEZ SÁEZ, SANTANDER (CANTABRIA) (ES)

(21) Appl. No.: 18/846,283

(22) PCT Filed: Mar. 10, 2023
(86) PCT No.: PCT/ES2023/070138

§ 371 Date: Sep. 12, 2024

(30) Foreign Application Priority Data
Mar. 15, 2022 (ES) P202230216

(51) Int. Cl. G21F 5/008; G21F 5/10; G21F 5/12

(52) U.S. Cl. CPC G21F 5/008; G21F 5/10; G21F 5/12

(57) ABSTRACT

A radioactive waste container comprising: a radionuclide containment barrier (1) delimiting a housing (16) for radioactive waste and comprising a first ferrule (11), a bottom (12), an upper flange (13), and a lid (14) fixed by bolts (15) to said upper flange (13); a shield (2) against gamma radiation, arranged externally with respect to the containment barrier (1) and comprising a second ferrule (21) with external fins (22) defining gaps between them, a lower closing flange (23), an outer lid (24) provided with bolts (25) for fixing to the upper flange (13) of the containment barrier (1), and an outer bottom (26) fixed to the lower closing flange (23); and a neutron shielding material (3) arranged in the gaps defined between the fins (22) of the second ferrule.

### TECHNICAL FIELD

The present invention relates to a container applicable to the storage of radioactive waste and, especially, of spent fuel from nuclear power plants.

### BACKGROUND ART

In the state of the art related to the indicated sector, various containers are known that can be generally classified into two types: concrete containers and metal containers. Such containers are useful to protect or envelop the waste canister to be protected or the rack where the elements involved in the spent fuel storage are housed.

In metal containers, different layers of different materials are used, having a thicker layer of steel, usually forged, between 200 and 300 mm. thick, with high mechanical abilities, whose main critical function is the protection against mechanical stresses such as impacts, seismic stresses or others. In addition, this layer forms a containment barrier against radionuclide leakage.

From the point of view of radiation shielding, this layer of forged steel, which given its high density has a high shielding ability against photonic radiation, must be complemented with an outer shielding against neutron radiation, against which steel does not provide sufficient efficiency.

This outer shield, usually some type of neutron poison, is arranged in an outer layer, surrounding the steel layer, and in turn is protected externally with a metal structure to prevent it from being damaged during handling.

In containers known in the state of the art, the steel layer used for protection against gamma radiation is usually a layer of forged steel, and it is the thickest layer in proportion to the rest of the layers that make up the protection system of the container. Forged steel is more expensive than steel or cast iron and is more difficult to handle for making specific shapes using moulds.

### SUMMARY OF THE INVENTION

The invention relates to a container for radioactive waste, specifically intended to house a rack containing the radioactive waste constituting a source of radioactive emission. The container object of the invention maintains an adequate proportion between the thickness of the different protection layers to achieve optimal protection without having to provide the high-thickness forged steel layer.

The container of the invention comprises:
a radionuclide containment barrier comprising: a first ferrule, a bottom and a lid; said containment barrier delimiting a housing for radioactive waste;
a gamma radiation shield arranged externally with respect to the containment barrier and comprising: a second ferrule provided externally with fins that define gaps between them; an outer lid and an outer bottom and;
a neutron shielding material arranged in the gaps defined between the fins of the second ferrule.

The attachment of the ferrules, lids and bottoms will be carried out by conventional means.

In a preferred embodiment, the containment barrier has an upper flange, and the lid has a sealing gasket fixed by bolts to said upper flange.

In a preferred embodiment, the shield has a lower closing flange, and the outer lid is provided with a sealing gasket and bolts for fixing it to the upper flange of the containment barrier.

The metal parts of the containment barrier are of forged steel.

The second ferrule arranged around the first ferrule of the containment barrier is a protective element against gamma radiation and is fixed to the components of said containment barrier by means of the lower closing flange.

The second ferrule is made up by a wall that externally has the fins that define the gaps to house the neutron shielding material.

These gaps are configured in such a way that no direct radiation will exit without the existence of neutron radiation absorbing material.

The lower closing flange is made of forged steel.

According to the invention, the container laterally comprises upper and lower forged steel trunnions fixed to the upper and lower flanges, which form a means for gripping and handling the container during operations.

The first ferrule of the containment barrier and the second ferrule are cylindrical and concentric, which allows the assembly of said second ferrule by inserting it through the lower area of the containment barrier, piece by piece. These parts are fixed to each other, achieving an integral behaviour by means of the lower closing flange.

According to the invention, the fins of the second ferrule are arranged longitudinally and distributed throughout the outline of said second ferrule. Thus, the fins of the second ferrule serve the following purposes of acting as:
Thermal bridge to evacuate the waste heat stored in the fuel elements.
Structural protection of the fuel elements during accident events by allowing higher deformation due to the orientation and thickness of their section.
Protection against neutron radiation, by configuring the gaps in which the neutron shielding material is housed.

All the fins have an inclination towards the same side with respect to the radial direction of the second ferrule, so that the neutron radiation absorbing material housed between said fins significantly reduces the risk of direct exit of the radiation to the outside without passing through said neutron radiation absorbing material.

Advantageously, the second ferrule is made of steel or cast iron allowing the necessary shapes to be made by moulding to configure the gaps into which the neutron shielding material is introduced.

### BRIEF DESCRIPTION OF THE CONTENTS OF THE DRAWINGS

In order to complement the description that is being carried out and with the purpose of facilitating the understanding of the characteristics of the invention, the present description is accompanied by a set of drawings wherein, by way of an illustrative and non-limiting example, the following has been depicted:

FIG. 1 shows a perspective view of one embodiment example of the radioactive waste container according to the invention.

FIG. 2 shows an elevation view of the container of the previous figure sectioned along a vertical plane.

FIG. 3 shows a top plan view of the container of FIG. 1 sectioned along a horizontal plane.

FIG. 4 shows a perspective view of the second ferrule of the gamma radiation shield.

FIG. 5 shows a perspective view of a variant embodiment of the gamma radiation shield provided with a third ferrule arranged externally with respect to the fins of the second ferrule.

FIG. 6 shows a perspective view of a variant embodiment of the gamma radiation shield in which the second and third ferrules are connected by the fins of said second ferrule.

FIG. 7 shows an elevation view of a variant embodiment of the second ferrule, sectioned along a vertical plane and formed by an upper portion and a lower portion superimposed and embedded one above the other by means of a socket.

### DETAILED EXPLANATION OF EMBODIMENTS OF THE INVENTION

In the example embodiment shown in the accompanying figures, the radioactive waste container object of the invention comprises:
a radionuclide containment barrier (1) comprising: a first ferrule (11), a bottom (12), an upper flange (13) and a lid (14) with a sealing gasket attached by bolts (15) to said upper flange (13); said containment barrier delimiting a housing (16) for radioactive waste;
a shield (2) against gamma radiation, arranged externally with respect to the containment barrier (1) and comprising: a second ferrule (21) externally provided with fins (22) defining gaps between them; a lower closing flange (23); an outer lid (24) provided with a sealing gasket and bolts (25) for fixing the sealing gasket to the upper flange (13) of the containment barrier (1) and an outer bottom (26) and;
a neutron shielding material (3) arranged in the gaps defined between the fins (22) of the second ferrule.

The aforementioned container for radioactive waste laterally comprises upper and lower trunnions (4) for gripping and transporting the container.

The containment barrier (1) is configured by attaching the bottom (12) to the first ferrule (11) and said first ferrule (11) to the upper flange (13).

The inner housing (16) of the container is closed by the lid (14) which is fixed to the upper flange (13) with bolts (15).

Preferably, the second ferrule (21), arranged around the containment barrier (1), is made of cast iron or steel, which facilitates the definition in the said second ferrule (21) of the fins (22) allowing to serve the following purposes of acting as:
Thermal bridge to evacuate the waste heat stored in radioactive waste.
Structural protection of radioactive waste during accident events by allowing higher deformation due to the orientation and thickness of their section.
Configuration of the gaps for housing the neutron shielding material (3).
Protection against gamma radiation by being made of cast iron or steel.

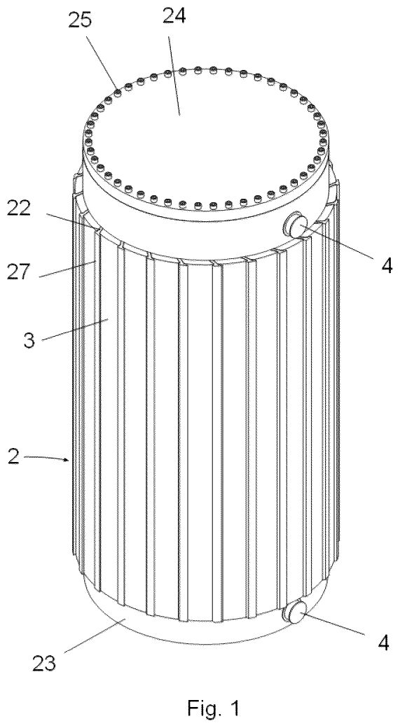

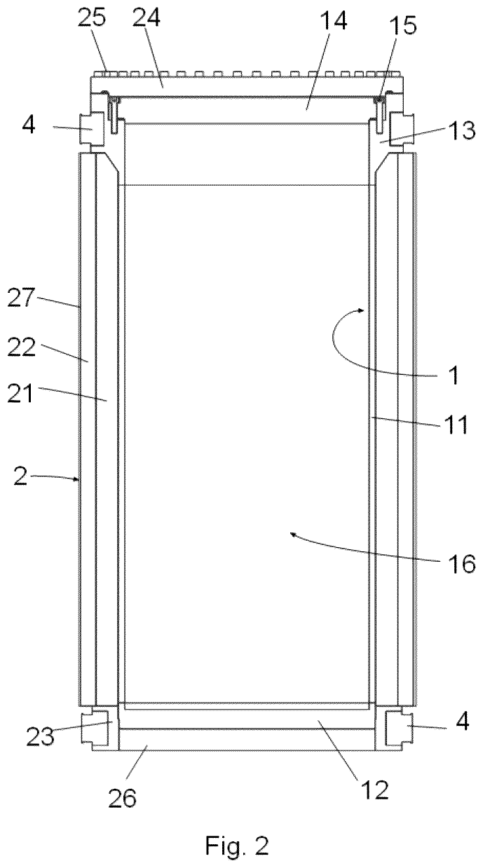

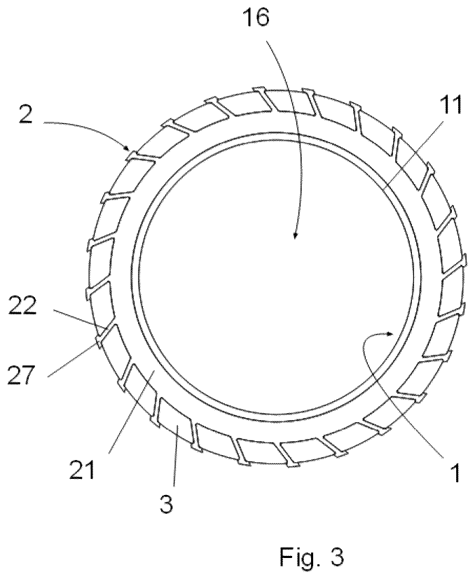

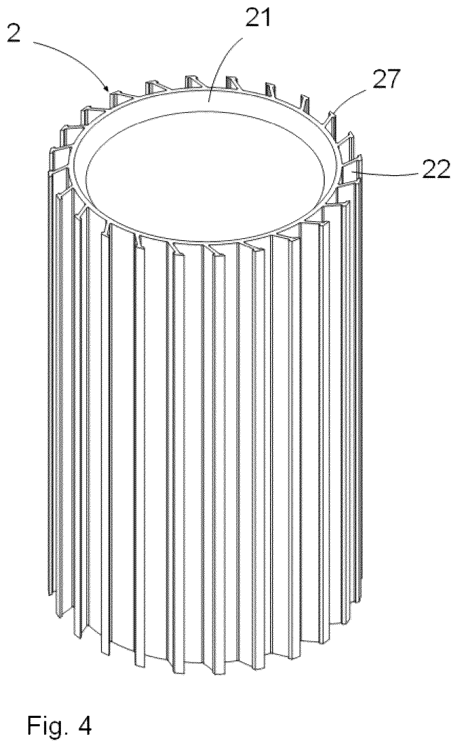

In the embodiment example shown in FIGS. 1 to 4, the fins (22) of the second ferrule (21) have at their end a stop (27) for retaining the neutron shielding material (3) in the gaps defined between said fins (22).

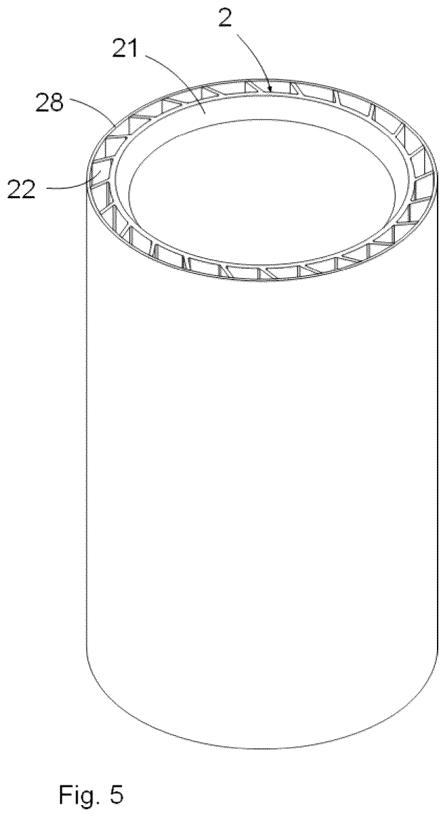

In the embodiment variant shown in FIG. 5, the gamma radiation shield comprises, around the second ferrule (21), a third ferrule (28) for retaining the neutron shielding material (3) in the gaps defined between the fins (22) of said second ferrule (21), making it unnecessary for said fins (22) to have at their end a stop (27) or a specific configuration for retaining the neutron shielding material (3) between them.

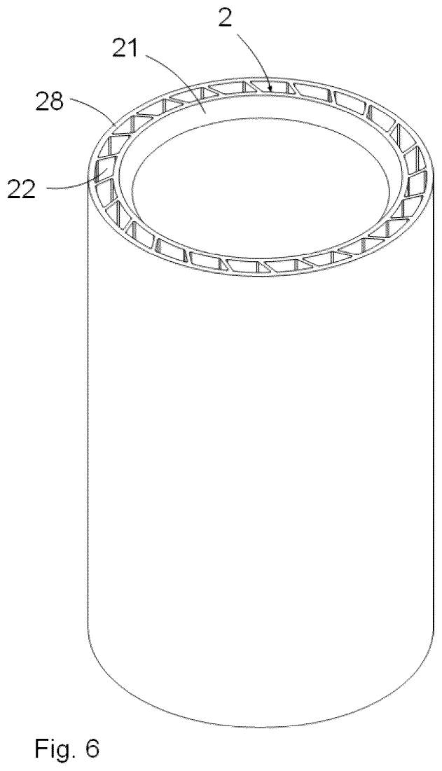

In the embodiment variant shown in FIG. 6, the second ferrule (21) and the third ferrule (28) of the shield (2) are attached by the fins (22) that delimit together with said ferrules (21, 28) the gaps for housing the neutron shielding material (3).

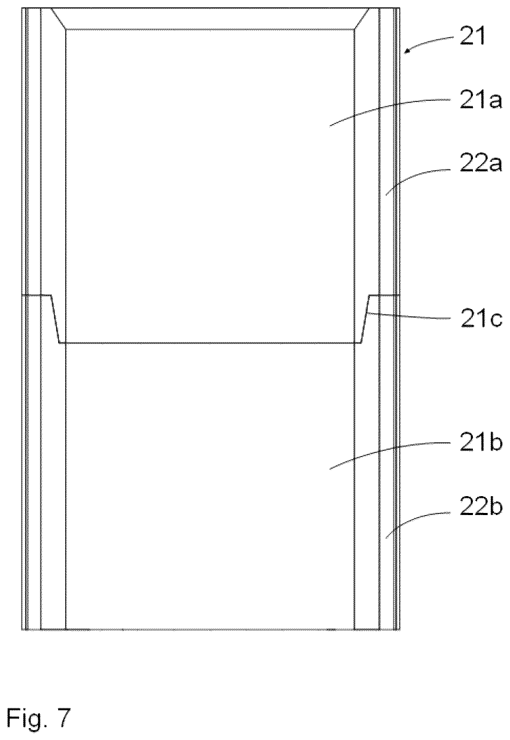

In the variant embodiment shown in FIG. 7, the second ferrule (21) is formed by an upper portion (21a) and a lower portion (21b) fitted one on top of the other by means of a socket (21c). Each portion (21a, 21b) has corresponding fins (22a, 22b).

The lower closing flange (23) is fixed to the bottom (12) of the containment barrier (1) causing the elements of said containment barrier (1) and the second ferrule (21) to work together.

The radioactive waste container is further protected and shielded with the outer bottom (26), which is fixed to the lower closing flange (23) and with the outer lid (24), which is fixed by bolts (25) to the upper flange (13) of the containment barrier (1).

Once the nature of the invention as well as an exemplary preferred embodiment have been sufficiently described, it is stated for all pertinent purposes that the materials, shape, size and arrangement of the described elements are susceptible to changes, provided this does not involve an alteration of the essential features of the invention which are claimed below.

1. Radioactive waste container, comprising:
a radionuclide containment barrier (1) comprising: a first ferrule (11), a bottom (12) and a lid (14); said containment barrier (1) delimiting a housing (16) for radioactive waste;
a gamma radiation shield (2) arranged externally with respect to the containment barrier (1) and comprising: a second ferrule (21) provided externally with fins (22) that define gaps between them; an outer lid (24) and an outer bottom (26);
a neutron shielding material (3) arranged in the gaps defined between the fins (22) of the second ferrule;
characterised in that the fins (22) of the second ferrule (21) have at their end a stop (27) for retaining the neutron shielding material (3) in the gaps defined between said fins (22).

2. Container, according to claim 1, characterised in that the containment barrier (1) comprises an upper flange (13), and the lid (14) has a sealing gasket fixed by bolts (15) to said upper flange (13).

3. Container, according to claim 2, characterised in that the bottom (12) and the upper flange (13) of the containment harrier (1) are fixed to the first ferule (11).

4. Container, according to claim 1, characterised in that the shield (2) comprises a lower closing flange (23), and the outer lid (24) is provided with a sealing gasket and bolts (25) for fixing it to the upper flange (13) of the containment barrier (1).

5. Container, according to claim 4, characterised in that the lower closing flange (23) is fixed to the bottom (12) of the containment barrier (1).

6. Container, according to claim 4, characterised in that the outer bottom (26) is fixed to the lower closing flange (23).

7. Container according to claim 1, characterised in that the fins (22) have an inclination towards the same side with respect to the radial direction of the second ferrule.

8. Container, according to claim 1, characterised in that it laterally comprises upper and lower trunnions (4), for gripping and transporting the container.

9. Container, according to claim 1, characterised in that the first ferrule (11) is made of forged steel and the second ferrule (21), provided with fins (22), is made of iron or cast steel.

10. (canceled)

11. Container, according to claim 1, characterised in that the gamma radiation shield comprises, around the second ferrule (21), a third ferrule (28) for retaining the neutron shielding material (3) in the gaps defined between the fins (22) of said second ferrule (21).

12. Container, according to claim 11, characterised in that the second ferrule (21) and the third ferrule (28) of the shield (2) are attached by the fins (22) that delimit, together with said ferrules (21, 28), the gaps for housing the neutron shielding material (9).

13. Container, according to claim 1; characterised in that the second ferrule (21) comprises an upper portion (21a) and a lower portion (21b) fitted one on top of the other by means of a socket (21c); and each portion (21a, 21b) of said second ferrule has corresponding fins (22a, 22b).
